(19) United States
(12) Patent Application Publication
(10) Pub. No.: US 2012/0312610 A1
(43) Pub. Date: Dec. 13, 2012

(54) BATTERY COOLING STRUCTURE FOR ELECTRIC VEHICLE

(75) Inventors: Dal Kim, Suwon (KR); Minwook Kim, Hwaseong (KR); Shinhyuk Yoon, Hwaseong (KR); Junho Bang, Hwaseong (KR)

(73) Assignees: KIA MOTORS CORPORATION, Seoul (KR); HYUNDAI MOTOR COMPANY, Seoul (KR)

(21) Appl. No.: 13/281,601

(22) Filed: Oct. 26, 2011

(30) Foreign Application Priority Data
Jun. 10, 2011 (KR) 10-2011-0056135

(51) Int. Cl. B60K 11/06; H01M 10/50

(52) U.S. Cl. 180/65.31

(57) ABSTRACT

Disclosed is a battery cooling structure for an electric vehicle which can cool a plurality of batteries mounted in the electric vehicle by forming a cooling channel around the batteries and blowing air therethrough. In the battery cooling structure for an electric vehicle disclosed herein, a first battery pack is disposed in the longitudinal direction of the vehicle, between a first-row of seats in the vehicle, a first battery housing is provided which is configured to allow through the first battery housing from the interior of the vehicle and is formed in the longitudinal direction to accommodate the first battery pack, and a first fan is disposed in the first housing to force the air in the vehicle into the first battery housing to be discharged to a trunk after cooling the first battery pack.

### CROSS-REFERENCE TO RELATED APPLICATIONS

The present application claims priority to Korean Patent Application Number 10-2011-0056135 filed Jun. 10, 2011, the entire contents of which application is incorporated herein for all purposes by this reference.

### BACKGROUND OF THE INVENTION

1. Field of the Invention

The present invention relates to a battery cooling structure for an electric vehicle, and more particularly, to a battery cooling structure for an electric vehicle that can cool a plurality of batteries by blowing air, and by forming a cooling channel around the batteries disposed in the electric vehicle.

2. Description of Related Art

Recently, there has been an active movement towards developing technology relating to hybrid vehicles and electric vehicle due to the rising oil prices, exhaustion of fossil energy and regulation related to clean air and pollution. The hybrid vehicle, however, has drawn particular attention because it uses two or more distinct power sources to move the vehicle. Hybrid vehicles are most commonly referred to as hybrid electric vehicles (HEVs), which combine an internal combustion engine and one or more electric motors. However, they are necessarily limited as such.

Electric vehicles, unlike hybrid vehicles, run solely off from battery power and a motor. Some of the main components of an electric vehicle are the battery, the inverter, and the motor. In order to increase the power performance and the traveling distance of the electric vehicle, some manufactures have mounted a large amount of batteries within the internal space of the vehicle.

However, the batteries generate heat when they are being operated, and thus they require system or device to control this generated heat to prevent overheating. For example, typically batteries are cooled by a free-air system or a water-cooling based system. The water-cooling based system has excellent cooling performance, but is relatively complicated and is highly cost prohibitive in relation to its commercial value, such that the air-cooling type is more often used than the water-cooling type. However, even these free-air cooling based systems of an electric vehicle using the air-cooling type, a technology of systematically cooling the battery is not applied and the battery is cooled by blowing only air.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

The present invention has been made in an effort to provide a battery cooling structure for an electric vehicle that can cool a battery generating heat by forming a cooling channel that induces the flow of air to the outside of a plurality of batteries mounted in an electric vehicle and blowing air into a cooling channel, in order to effectively cool the batteries.

An exemplary embodiment of the present invention provides a battery cooling structure for an electric vehicle in which a first battery pack is disposed in the longitudinal direction of the vehicle, between a first-row of seats in the vehicle, a first battery housing configured to flow air inside from the interior of the vehicle and formed in the longitudinal direction of the vehicle to accommodate the first battery pack is provided, and a first blowing fan that forces the air in the vehicle into the first battery housing to be discharged to a trunk after cooling the first battery pack is completed.

The illustrative embodiment of the present invention may also include an intake that is connected with the interior of the vehicle and formed on a side of the battery housing to allow air to flow therein. Additionally, the first battery pack may be composed of a plurality of battery modules disposed perpendicular to the bottom and the battery modules and arranged with gaps from other adjacent battery modules in the direction perpendicular to the longitudinal direction of the vehicle. Also in some embodiment of the present invention, the intake duct may be connected to a side of the second-row seat.

In some embodiments of the illustrative embodiment of the present invention, a lower duct that spaces the first battery pack from the bottom of the vehicle and allows the air to flow along the bottom of the first battery pack may also be disposed in the first battery housing.

In some embodiments of the illustrative embodiment of the present invention, a second battery pack may be provided under a second-row seat of the vehicle in the width direction of the vehicle, and a second battery housing may be formed in the width direction of the vehicle to accommodate the second battery pack and communicate with the first battery housing. Furthermore, a plurality of battery modules constituting the second battery pack may be stacked with gaps therebetween, in parallel with the bottom of the battery housing.

Additionally, in some embodiments of the illustrative embodiment of the present invention, the battery modules stacked in the second battery pack may be arranged in the longitudinal direction and the width direction of the vehicle, with a gap C between a first battery module in a first row positioned at the front portion of the vehicle and a second battery module in a second row behind the first row, in the longitudinal direction of the vehicle.

Additionally, in some embodiments of the illustrative embodiment of the present invention, a third battery pack may be disposed in the width reaction of the vehicle in the trunk. In this embodiment, a third battery housing accommodating the third battery pack and having an intake duct communicating with the interior at one side and a discharge duct connected to the trunk at the other side is provided, and a second blowing fan is disposed in the third battery housing. The battery modules constituting the third battery pack may be stacked with gaps therebetween, in parallel with the bottom of the third battery housing. The battery modules stacked in the third battery pack may be arranged in the longitudinal direction and the width direction of the vehicle, with gaps therebetween in the width direction of the vehicle.

According to the exemplary embodiments of the present invention, it is possible to an increase the traveling distance of the electric vehicle and improve the power performance by mounting a battery pack in the console in the center in the vehicle, under the second-row seat (i.e., the back seat), and the trunk. Further, it is possible to effectively cool a plurality of battery packs mounted in an electric vehicle, by cooling the battery pack via uniformly supplying air in the vehicle, with the battery packs positioned in a cooling channel that can control the flow of air in the vehicle.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a schematic view showing the positions where batter packs are disposed in an electric vehicle, in a battery cooling structure for an electric vehicle according to an exemplary embodiment of the present invention.

FIG. 2 is a perspective view showing a first battery housing and a second battery housing and the flow of air in the first battery housing and the second battery housing, in the battery cooling structure for an electric vehicle according to an exemplary embodiment of the present invention.

FIG. 3 is a cross-sectional view showing the air flow in the first battery housing in the battery cooling structure for an electric vehicle according to an exemplary embodiment of the present invention.

FIG. 4 is a cross-sectional view taken along the line A-A of FIG. 3.

FIG. 5 is a plan view showing the air flow in the first battery housing and the second battery housing in the battery cooling structure for an electric vehicle according to an exemplary embodiment of the present invention.

FIG. 6 is a cross-sectional view taken along the line B-B of FIG. 5.

FIG. 7 is a perspective view showing a the third battery housing and the air flow in the battery cooling structure for an electric vehicle according to an exemplary embodiment of the present invention.

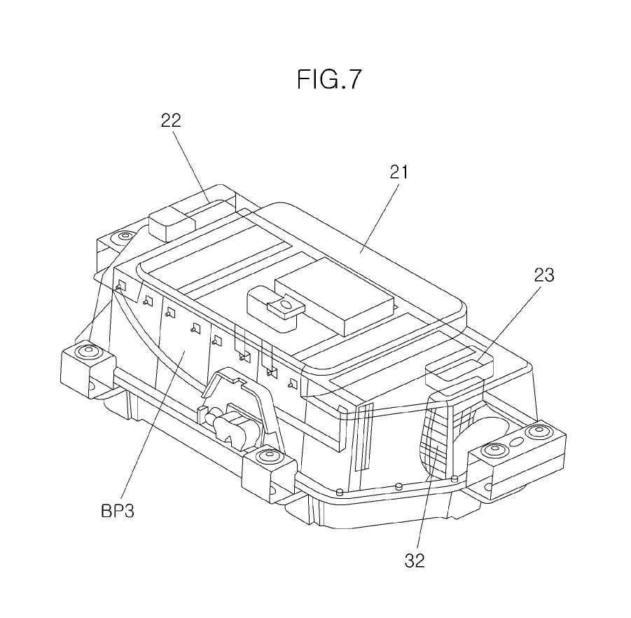

FIG. 8 is a perspective view showing the position where the third battery housing is disposed in the battery cooling structure for an electric vehicle according to an exemplary embodiment of the present invention.

FIG. 9 is a perspective view showing an intake duct connected with the third battery housing in the battery cooling structure for an electric vehicle according to an exemplary embodiment of the present invention.

FIG. 10 is a cross-sectional view of FIG. 7.

FIG. 11 is a cross-sectional view taken along the line C-C of FIG. 10.

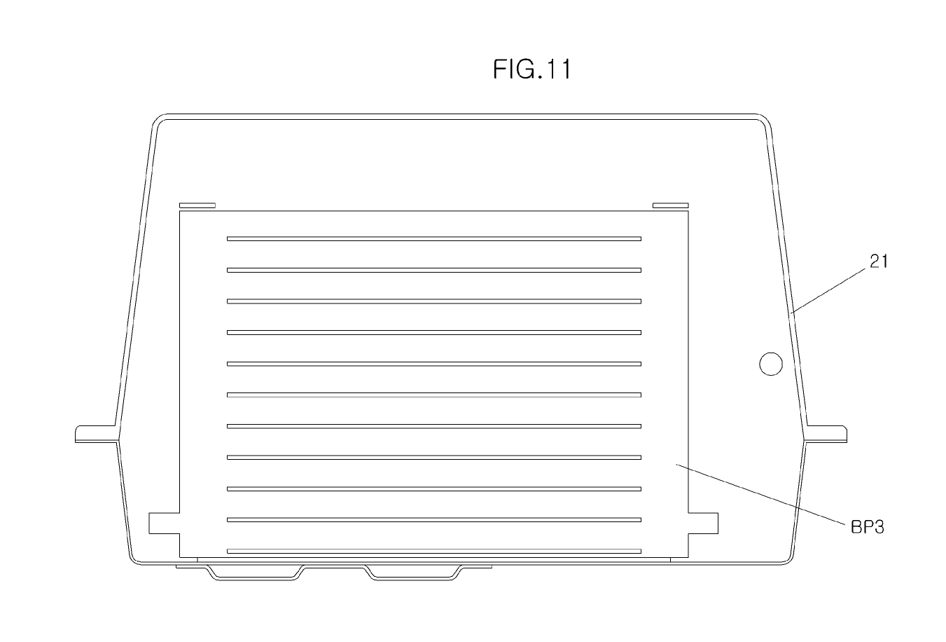

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

A battery cooling structure for an electric vehicle according to an exemplary embodiment of the present invention is described with reference to the accompanying drawings. A battery cooling structure for an electric vehicle according to an exemplary embodiment of the present invention includes a plurality of battery packs BP1, BP2, and BP3 mounted in an electric vehicle 1 to supply power for the electric vehicle that are disposed in parallel with the flow direction of cooling air, battery housings 11, 12, and 21 that accommodate battery packs BP1, BP2, and BP3 and form an air channel, and blowing fans 31 and 32 that force the cooled air into battery housings 11, 12, and 21.

The batteries of the electric vehicles constitute battery packs BP1, BP2, and BP3 in a predetermined unit by collecting battery modules manufactured in a predetermined size and battery packs BP1, BP2, and BP3 constitute a battery system of the electric vehicle. The battery modules or battery packs BP1, BP2, and BP3 are arranged to fit in the internal space of the vehicle and are electrically connected in series or in parallel after being mounted in the vehicle, such that power for driving motors of electric vehicle is supplied accordingly.

Battery packs BP1, BP2, and BP3 are arranged such that the battery modules of battery packs BP1, BP2, and BP3 are in parallel with the flow direction of the cooling air. By arranging the battery modules in parallel with the flow direction of the cooling air, the cooling air provided over the battery pack surfaces is smoothly supplied to the battery modules without interfering with the flow of cooling air.

Battery housing 11, 12, and 21 accommodate battery packs BP1, BP2, and BP3 and the space between the inner sides of battery housings 11, 12, and 21 and the outer sides of battery packs BP1, BP2, and BP3 embody effectively a cooling channel through which the cooling air flows. Battery housings 11, 12, and 21 improves the aesthetic appearance of the battery packs BP1, BP2, and BP3 not exposed, by accommodating battery packs BP1, BP2, and BP3. Furthermore, battery housings 11, 12, and 21 are connected with the interior of the vehicle one side and with the trunk of the vehicle on the other side of the battery housings such that the cooled air flows inside from the interior of the vehicle and is discharged to the trunk after cooling battery packs BP1, BP2, and BP3 accommodated therein.

Blowing fans 31 and 32 are disposed on one side of battery housings 11, 12, and 21 and force the external air to flow into battery housings 11, 12, and 21 so that the cooling air flows in battery housings 11, 12, and 21.

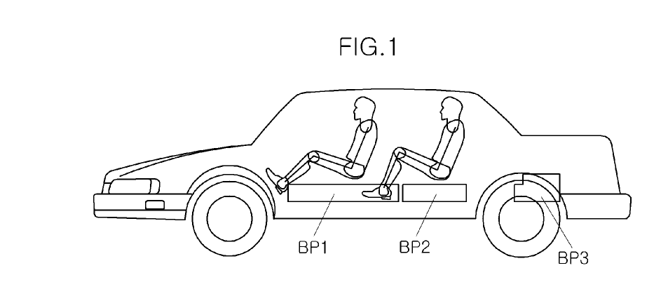

In this configuration, in order to increase the traveling time of the electric vehicle, the battery packs may be mounted in groups of at least one or more or preferably all of under the first-row of seats in the center of the vehicle, under the second-row seat, and the trunk, and a battery cooling structure is applied to them accordingly. That is, as shown in FIG. 1, preferably, first battery pack BP1 is mounted under the center first-row seats in the vehicle, a second battery pack BP2 is mounted under the second-row seats, and third battery pack BP3 is mounted in the trunk, to allow traveling time is increased or the power performance is improved in the electric vehicle due to the addition of multiple battery packs.

First, the battery cooling structure applied to cool first battery BP1 mounted under the center in the electric vehicle is described. The first battery housing 11 is disposed in a tunnel type orientation and structure under the center of a first-row seat and first battery pack BP1 is disposed therein. That is, first battery pack BP1 is arranged at the middle of the first-row left and right seats in the longitudinal direction of the vehicle and first battery housing 11 is disposed outside the first battery pack BP1.

By mounting a plurality of battery packs the present invention is able to increase the traveling distance or improve the performance in electric vehicle 1, and as a method for achieving it, first battery pack BP1 is mounted in the longitudinal direction of the vehicle by using the space underneath the console box disposed between the first-row left and right seats.

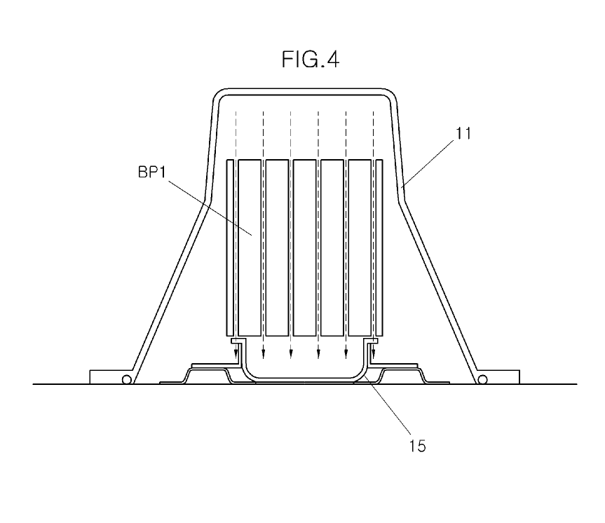

Since the space between the first-row left and right seats is narrow, the battery modules of first battery pack BP1 are arranged vertically along this narrow passage toward the bottom of the battery housing, and as shown in FIG. 4, arranged with a gap from adjacent other battery modules in the direction perpendicular to the traveling direction of the vehicle. The cooling air flowing inside through the space formed between the battery modules cools the battery module as the air flows therethrough. Meanwhile, the air also flows between first battery pack BP1 and the bottom of the battery housing by arranging first battery pack BP1 with a space between the first battery pack and the bottom of the battery housing.

The first battery housing 11 is implemented to be able to accommodate the first battery pack BP1 arranged in the longitudinal direction of the vehicle and is formed with a gap between the inner side and the first battery pack BP1 to form a channel configured to allow cooled air to flow therethrough.

Meanwhile, an intake hole 13 through which the cooled air flows inside is formed on one side of the first battery housing 11 and a discharge hole, through which the air which has cooled the first battery pack BP1 is discharge to the outside the housing, is formed on the other side. The intake hole 13 allows the first battery housing 11 to fluidly communicate air with the interior of the vehicle so that the cooled air flows into the battery housing. The other side of first battery housing 11 is connected to a side of second battery housing 12 disposed under the second-row seat so that the air passing through first battery housing 11 flows again into second battery housing 12.

Furthermore, a lower duct 15 is formed in first battery housing 11 so that the first battery pack BP1 is spaced apart from the bottom of the vehicle and a channel is formed so that air is able to flow between the bottom of first battery pack BP1 and the bottom of the vehicle.

Second battery pack BP2 is disposed under the second-row seat. In fuel combustion vehicles, the fuel tank is typically mounted under the second-row seat. However, electric vehicle do not require a fuel tank, so in place of the fuel tank the second battery pack BP2 is mounted in the space under the second-row seat. Since the section under the second-row seat is a space that is larger in the width direction than the longitudinal direction of the vehicle, the second battery pack BP2 is mounted with the battery modules stacked on both left and right sides under the second-row seat.

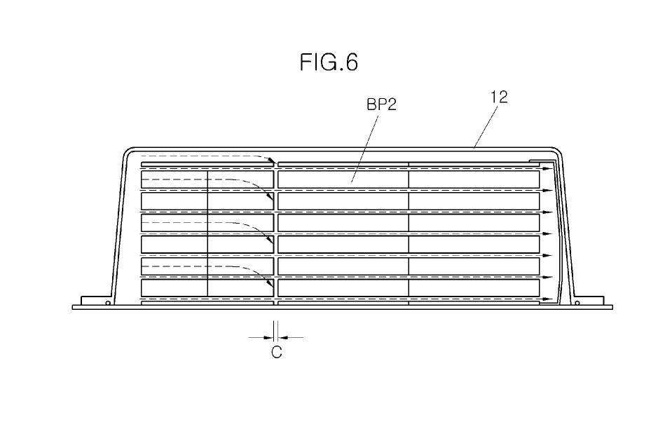

For example, as shown in FIG. 6, when the battery modules are stacked, channels through which the air can flow are formed by defining gaps between the stacked battery modules. As described above, when second battery pack BP2 is mounted under the second-row seat, the second battery housing 12 is also disposed to accommodate second battery pack BP2.

Meanwhile, since battery pack BP2 is arranged in the second battery housing 12 in a horizontal or width direction rather than in the longitudinal direction of the vehicle, gaps are defined between the battery modules of battery pack BP2 in order allow the air flowing into second battery housing 12 to be sufficiently supplied in the width direction of the vehicle. The battery modules are arranged in stacking structure with gaps and arranged in a plurality of columns and rows in the longitudinal direction and the width direction of the vehicle. In particular, a gap C is defined between the first column positioned in the front portion of the vehicle in the longitudinal direction and the second column behind the first column, in the battery modules. Therefore, the air is sufficiently supplied in the width direction and sufficiently mixed via turbulence. In doing so, a temperature difference in second battery pack BP2 is reduced and efficient cooling is achieved. Further, the gap may be defined between the second column and the third column. In this embodiment the shape of the gape and the size of the gap are defined by analyzing the air flow in second battery housing 12 such that the internal temperature difference is within a predetermined level.

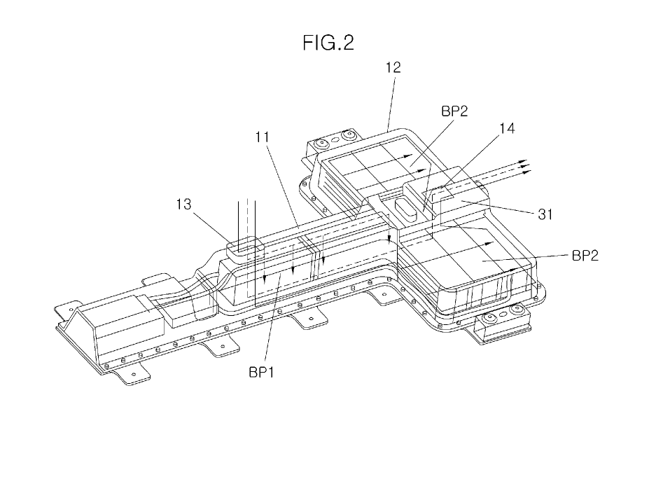

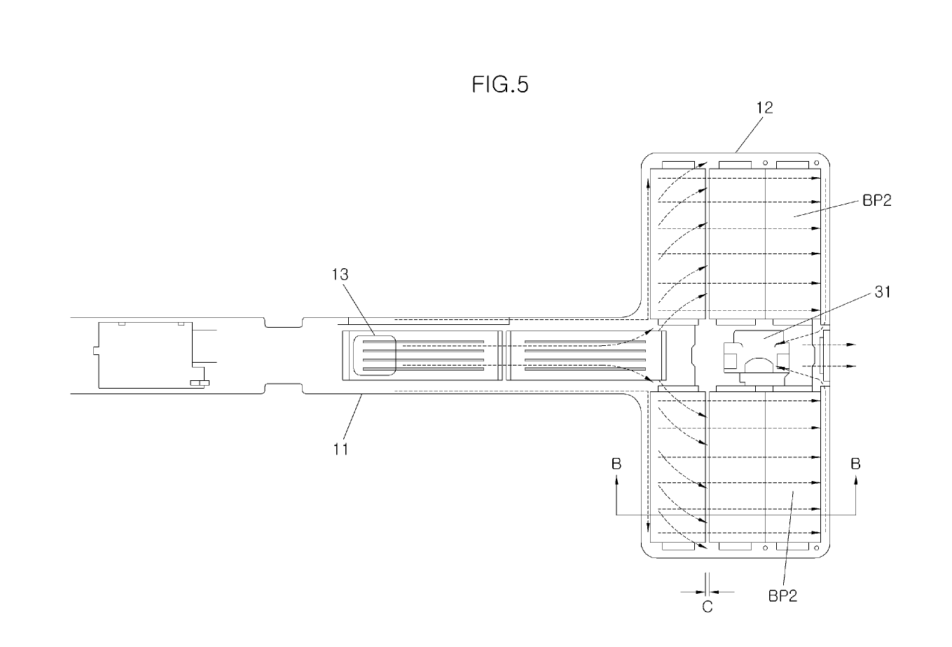

In this embodiment, the second battery housing 12 connects with the first battery housing 11 so that the cooling air passing through the first battery housing 11 is able to flow into second battery housing 12. Thus, the fist battery housing 11 and the second battery housing 12 are in fluid communication with each other. That is, as shown in FIGS. 2 to 5, the first battery housing 11 and the second battery housing may be embodied as one battery housing constructing them as one single continuous housing. The first battery housing 11 in this illustrative embodiment is formed in the longitudinal direction of the vehicle and the second battery housing 12 is formed in the width direction of the vehicle, so that the combination of the first battery housing 11 and the second battery housing 12 form a T-shape.

Therefore, the air flowing through the center of the second battery housing 12 is divided to the left and right and cools the second battery packs BP2 accommodated therein. The air is then converged and discharged out of the second battery housing 12.

The first blowing fan 31 sucks the air in first battery housing 11 and the second battery housing 12, which are connected and are in fluid communication with each other, through the housings and to the outside. That is, the first blowing fan 31 is positioned in a rearward portion of second battery housing 12 so that air in the two housings can be sucked through the housings thereby cooling the battery modules therebetween.

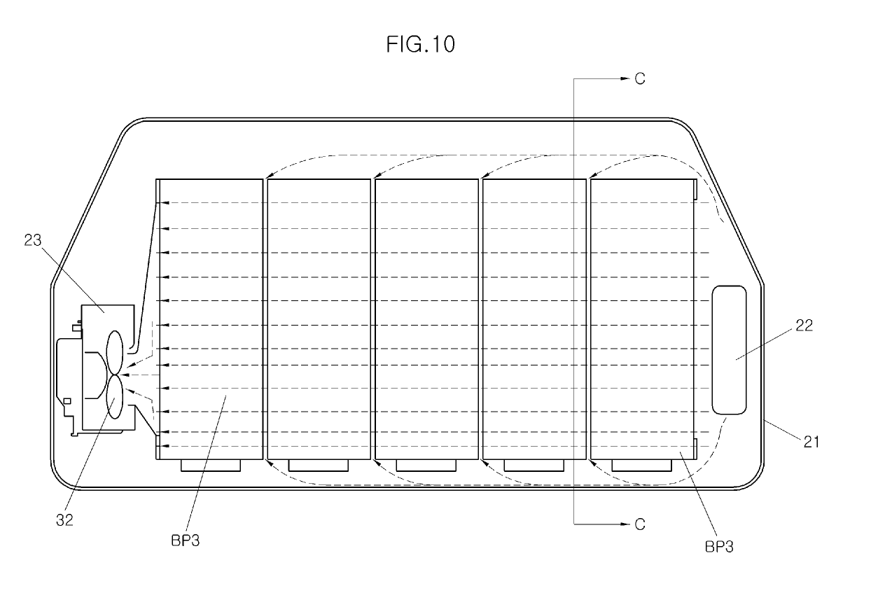

In some embodiments of the present invention, a third battery pack BP3 may also be mounted in the trunk to provide an even greater travel distance and power performance to an electric vehicle. In this configuration, a plurality of battery modules are combined to form a third battery pack BP3 which are each arranged with a gap therebetween in the flow direction of the air and the third battery housing 21 accommodates the third battery pack. The battery modules of third battery pack BP3 are stacked and arranged in columns and rows in the width direction and the longitudinal direction of the vehicle. In particular, the gaps are defined such that the flow of the cooling air is made smooth in the width direction of the vehicle, as shown in FIG. 10, in order to mix the cooling air. Forming of the gaps and the sizes of the gaps are determined by analyzing the air flow in third battery housing 21.

The third battery housing 21 allows the cooling air to flow in the width direction of the vehicle, in the trunk. That is, the general flow of the cooing air in third battery housing 21 is directed in the width direction of the vehicle, by arranging the battery modules of third battery pack BP3 with the gaps in the width direction of the vehicle and accommodating third battery pack BP3 in third battery housing 21.

The third battery housing 21 functions as a casing that prevents third battery pack BP3 mounted in the trunk from being exposed external elements while at the same time forming a channel for the cooling air. Further, it is possible to load objects on a battery cover 24 by mounting battery cover 24 outside the third battery housing 21 thereby allowing the trunk to be used as a cargo space as it was intended.

An intake duct 23 allows the third battery housing 21 to fluidly communicate with the interior of the vehicle and is disposed on one side of the third battery housing 21 and a discharge duct 23 for discharging the air that has cooled the battery to the outside is disposed on the other side.

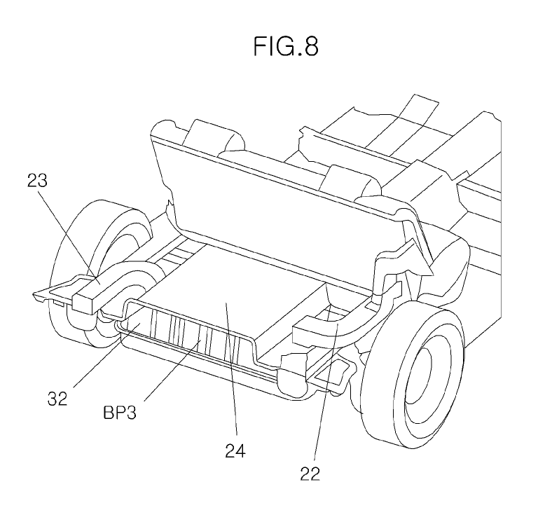

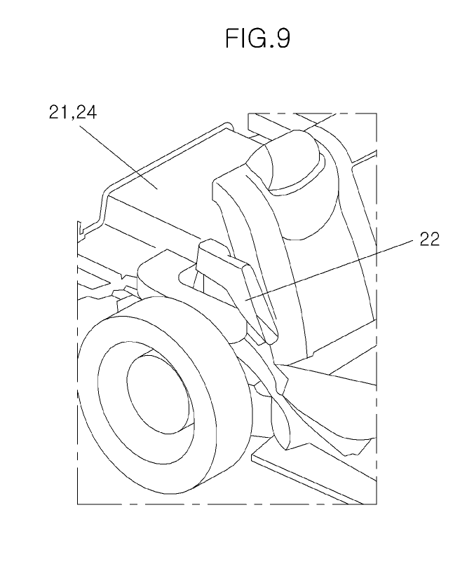

The intake duct 22 connects to the interior of the vehicle, for example, as shown in FIGS. 8 and 9, through the side of the second-row seat with third battery housing 21. In this embodiment, the intake duct 22 may be connected with a rear package and a C-filler, other than the side of the second-row seat.

A discharge duct 23 is connected with the other side of the third battery housing 21, preferably, on the opposite side of the intake duct 22 and a discharge grill of the vehicle's body so that the air that has cooled the third battery pack BP3 is discharged to outside of the vehicle.

A second blowing fan 32 for blowing cooling air inside from outside the vehicle may also disposed on one side in third battery housing 21.

The operation of the battery cooling structure for an electric vehicle having the configuration according to the present invention is described.

As the blowing fans 31 and 32 operate to cool the battery packs BP1, BP2, and BP3 mounted in an electric vehicle, air that is lower in temperature than the battery packs BP1, BP2, and BP3 flows inside and cools the battery packs BP1, BP2, and BP3. As the first blowing fan 31 operates, the interior air flows inside and cools the first battery pack BP1 and second battery pack BP2 while passing through the first battery pack BP1 and the second battery pack BP2, and when the second blowing fan 32 operates, the third battery pack BP3 is cooled.

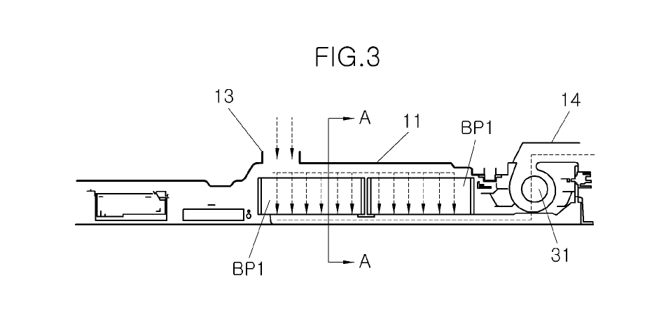

First, as the first blowing fan 31 operates, the interior air flows into the first battery housing 11 through intake aperture 13 of the first battery housing 11. The air flowing in the first battery housing 11, as shown in FIGS. 2 and 3, cools the first battery pack BP1 while flowing in the longitudinal direction of the first battery housing 11, that is, the longitudinal direction of the vehicle, through the spaces within the first battery housing 11 and the first battery pack BP1.

The air flow in the first battery housing 11 in the above process will now be described. The air flows along an upper and lower portion and a left and right side of the first battery pack BP1. Thus, some of the air flows and cools from the upper portion to the lower portion of the first battery pack BP1, as shown in FIG. 4. The air that has passed the first battery housing 11 flows into the second battery housing 12 and cools the second battery pack BP2. The air flowing in the second battery housing 12 is divided to the left and right and cools the second battery pack BP2 while flowing through second battery housing 12.

Some of the air flowing in first battery housing 11 flows while cooling the first battery pack BP1 (flows indicated by a dotted arrow in FIG. 2) and another portion of the intake air flows directly into the second battery housing 12 through the upper portion and the lower portion and the left and right side spaces of the first battery pack BP1 (flows indicated by a solid line). In particular, the second battery pack BP2 is smoothly divided left and right by defining a gap C between a first column and a second column with respect to the flow direction of the air. The air passing through the first battery housing 11 and the second battery housing 12 is discharged to the trunk from the second battery housing 12 and then to the outside of the vehicle through a discharge grill.

Meanwhile, the second blowing fan 32 is operated to cool the third battery pack BP3. As the second blowing fan 32 is operated, the interior air flows into third battery housing 21 through intake duct 22 providing fluid communication with the interior of the vehicle and cools the third battery pack BP3 while flowing through third battery housing 21. In this process, since the battery modules in the third battery pack BP3 are arranged with gaps therebetween, the air is supplied between the battery modules while flowing from intake duct 22 to discharge duct 23 of the third battery housing 21, such that effective cooling can be achieved. The air discharged to the trunk through discharge duct 23 is then discharged outside through the discharge grill.

According to exemplary embodiments of the present invention, it is possible to increase travel distance of an electric vehicle and at the same time improve performance by mounting battery packs in available spaces of a vehicle. Further, it is possible to effectively remove the heat generated from the batteries by allowing the interior air of a vehicle to flow into the battery housings accommodating the battery packs.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A battery cooling structure for an electric vehicle, comprising:
a cooling structure configured to cool a plurality of battery packs mounted in the electric vehicle by blowing air over the plurality of battery packs;
a first battery pack is disposed in the longitudinal direction of the vehicle in the cooling structure, between a first-row of seats in the electric vehicle;
a first battery housing configured to allow air flow through the inside of the first battery housing from the interior of the electric vehicle and formed in a longitudinal direction to accommodate the first battery pack; and
a first fan disposed in the cooling structure and configured to suck the air in the vehicle into the first battery housing to be discharged into a trunk after cooling the first battery pack.

2. The battery cooling structure as defined in claim 1, wherein an intake is configured to fluidly communicate the first battery housing with an interior of the vehicle and allow air in the interior of the vehicle to flow into the first battery housing, the intake formed on one side of the first battery housing.

3. The battery cooling structure as defined in claim 1, wherein the first battery pack is composed of a plurality of battery modules disposed perpendicular to the bottom surface of the first battery housing, wherein the plurality of battery modules are arranged with gaps between adjacent battery modules in the direction perpendicular to the longitudinal direction of the vehicle.

4. The battery cooling structure as defined in claim 1, wherein a lower duct disposed in the first battery housing is configured to provide a space between the first battery pack and the bottom surface of the vehicle and allow the air to flow along the bottom surface of the first battery pack.

5. The battery cooling structure as defined in claim 1, further comprising:
a second battery pack is provided under a second-row seat within the vehicle in a width direction of the vehicle, and
a second battery housing formed in the width direction of the vehicle to accommodate the second battery pack and configured to be connected and in fluid communication with the first battery housing.

6. The battery cooling structure as defined in claim 5, wherein a plurality of battery modules constituting the second battery pack are stacked with gaps therebetween, in parallel with the bottom surface of the second battery housing.

7. The battery cooling structure as defined in claim 6, wherein the battery modules stacked in the second battery pack are arranged in the longitudinal direction and the width direction of the vehicle, with gaps between the battery modules in a first column positioned in the front portion of the electric vehicle and the battery modules in a second column behind the first column, in the longitudinal direction of the vehicle.

8. The battery cooling structure as defined in claim 1, further comprising:
a third battery pack is disposed in the width direction of the vehicle in the trunk;
a third battery housing accommodating the third battery pack and having an intake duct connected to and in fluid communication with one side of the vehicle interior and a discharge duct connected to a trunk on the other side; and
a second fan disposed in the third battery housing.

9. The battery cooling structure as defined in claim 5, wherein the battery modules constituting the third battery pack are stacked with gaps therebetween, in parallel with the bottom surface of the third battery housing.

10. The battery cooling structure as defined in claim 9, wherein the battery modules stacked in the third battery pack are arranged in the longitudinal direction and the width direction of the vehicle, with gaps therebetween in the width direction of the vehicle.

11. The battery cooling structure as defined in claim 8, wherein the intake duct is connected to a side of the second-row seat.
